(19) United States
(12) Patent Application Publication
(10) Pub. No.: US 2016/0232792 A1
(43) Pub. Date: Aug. 11, 2016

(54) UAV Inspection Flight Segment Planning

(71) Applicant: Izak Jan van Cruyningen, Saratoga, CA (US)

(72) Inventor: Izak Jan van Cruyningen, Saratoga, CA (US)

(21) Appl. No.: 14/616,592

(22) Filed: Feb. 6, 2015

(51) Int. Cl. G08G 5/00

(52) U.S. Cl. CPC G08G 5/003

(57) ABSTRACT

FIG. 3 shows a representation on display 60 of a transmission line tower 42 supporting phase conductors 46, 48, 50 and shield wires 36 and 38 within right of way 58. The angle of view 56 of aerial camera 16 is illustrated by a cone originating at the lens in camera 16. The sample distance at different locations on the object of interest is displayed either as a tooltip 72 for an input device 62 represented by a cursor 70; or on the screen upon a touch for touch input.

The operator interactively decides on the tradeoff between angle of view 56 and sample distance at different locations on the object of interest by manipulating the cone representing angle of view 56. After selecting angle of view 56 with a click or touch, it can be translated 74 or rotated 76 to plan to capture as much of the object of interest as possible while meeting sample distance objectives. When the operator is satisfied with the compromise, a click or tap on a save or next button 78 stores the geometry for flight segment 30.

### CROSS-REFERENCE TO RELATED APPLICATIONS

This application claims the benefit of provisional patent application Ser. No. 61/937,048 filed 2014 Feb. 7 by the present inventor.

### BACKGROUND

### Prior Art

Unmanned aerial vehicles (UAV) are an excellent vehicle for close-in inspection of objects of interest on the ground. They do not require the same safety margin as manned flight, so they can be flown at much lower heights above ground, close-in to the object of interest. Regulatory agencies limit their weight, speed, and/or the height above ground under which they may be used. For example, in the United States they must currently stay under 400 feet above ground level. New regulations are forthcoming.

The plan for an inspection flight must balance between the minimum field of view, the maximum sample distance, and the photo overlap for the mission. Current aerial photogrammetry for mapping and measuring areas of the earth's surface emphasizes vertical photographs taken along the nadir. For a given camera and lens, the desired ground sample distance dictates the flying height and hence the field of view at the ground. Then the camera framing rate and the desired photo overlap dictate the flight speed and the distance between adjacent flight paths. These relationships are well defined and the flight plan can be generated automatically, as currently implemented in several flight planning programs.

Close-in inspection of ground-based objects uses oblique images to capture the sides, and possibly bottom, of the objects of interest. It can be difficult to meet the field of view and sample distance objectives for the inspection. When these requirements cannot be met automatically, then an operator has to make the tradeoff to complete the flight plan.

### SUMMARY

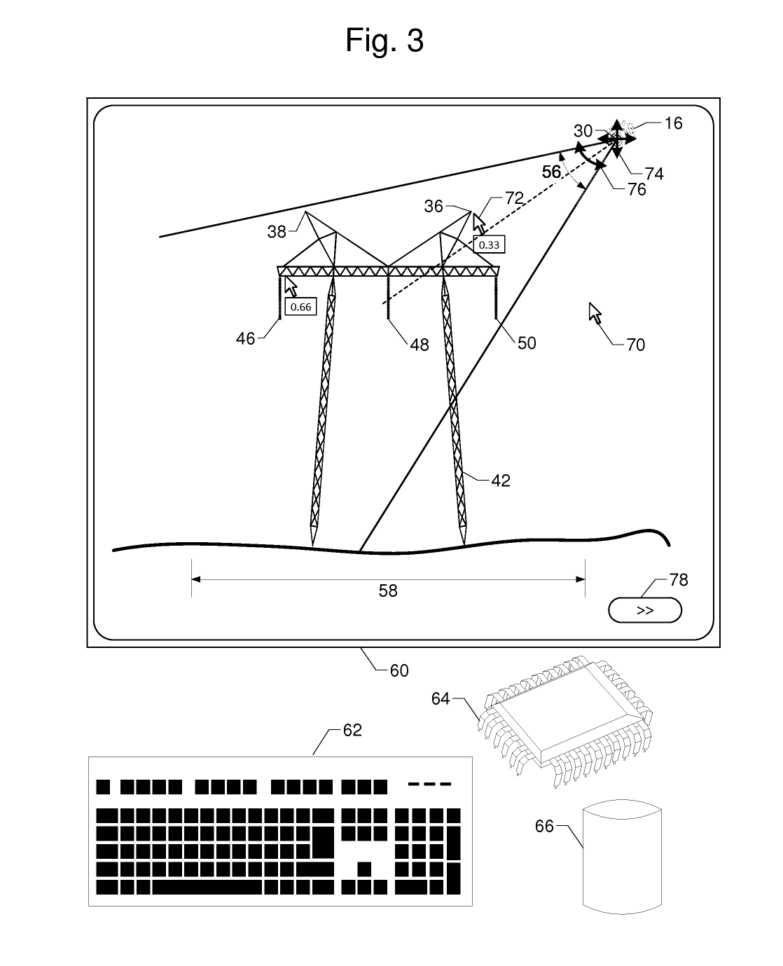

FIG. 3 shows a representation on display 60 of a transmission line tower 42 supporting phase conductors 46, 48, 50 and shield wires 36 and 38 within right of way 58. The angle of view 56 of aerial camera 16 is illustrated by a cone originating at the lens in camera 16. The sample distance at different locations on the object of interest is displayed either as a tooltip 72 for an input device 62 represented by a cursor 70; or on the display upon a touch for touch input.

The operator interactively decides on the tradeoff between angle of view 56 and sample distance at different locations on the object of interest by manipulating the cone representing angle of view 56. After selecting angle of view 56 with a click or touch, it can be translated 74 or rotated 76 to plan to capture as much of the object of interest in an image as possible while meeting sample distance objectives. When the operator is satisfied with the compromise, a click or tap on a save or next button 78 stores the geometry for flight segment 30.

### Advantages

Although flight planning is well known in the prior art, various aspects of the embodiments of my interactive flight segment planner are advantageous because:
It is an intuitive display of the angle of view,
Sample distances at the object of interest are calculated and displayed automatically,
The operator can rapidly try a number of camera locations and rotations to compare field of view against sample distance,
The tradeoffs are visible and the flight plan for each segment can be tuned to meet inspection objectives.

Other advantages of one or more aspects will be apparent from a consideration of the drawings and ensuing description.

### FIGURES

1. Perspective view of utility corridor inspection flight path for transmission lines.

2. Cross-path section of utility corridor inspection flight path for transmission lines.

3. Interactive interface with cross-path section representation in flight planning software.

4. Interactive interface with perspective view representation in flight planning software.

5. Flight planning flowchart for determining flight parameters.

### DETAILED DESCRIPTION

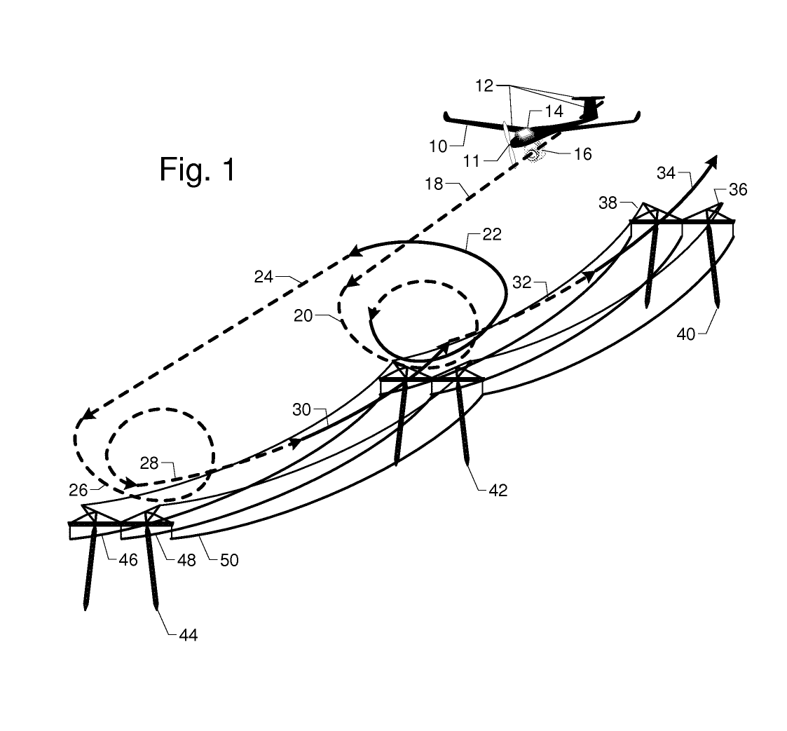

This section describes several embodiments of the interactive flight segment planner with reference to FIGS. 1-5.

FIG. 1 is a perspective view of a utility corridor inspection flight path for power transmission lines. An aerial inspection system includes an airframe 10 that supports power plant 11, control surfaces 12, autopilot 14, and camera 16. Towers 40, 42, and 44 support phase conductors 46, 48, and 50, as well as shield wires 36 and 38. Airframe 10 inspects the corridor in a flight path combining linear right of way glide 18; followed by spiral tower glide 20 around tower 42; power climb 22; linear right of way glide 24; and spiral tower glide 26 around tower 44. On the return path airframe 10 does a close-in conductor inspection by flying catenary glides 28, 32 on the downslopes and catenary climb 30, 34 on the upslopes.

This example is for a single circuit 500 kV transmission line where towers 40, 42, and 44 are ˜40 m high, ˜25 m wide, and spaced 200-600 m apart. Phase conductors 46, 48, and 50 are aluminum strands over a steel core with a total diameter of 3-6 cm. Shield wire 36 and 38 are 1-2 cm in diameter.

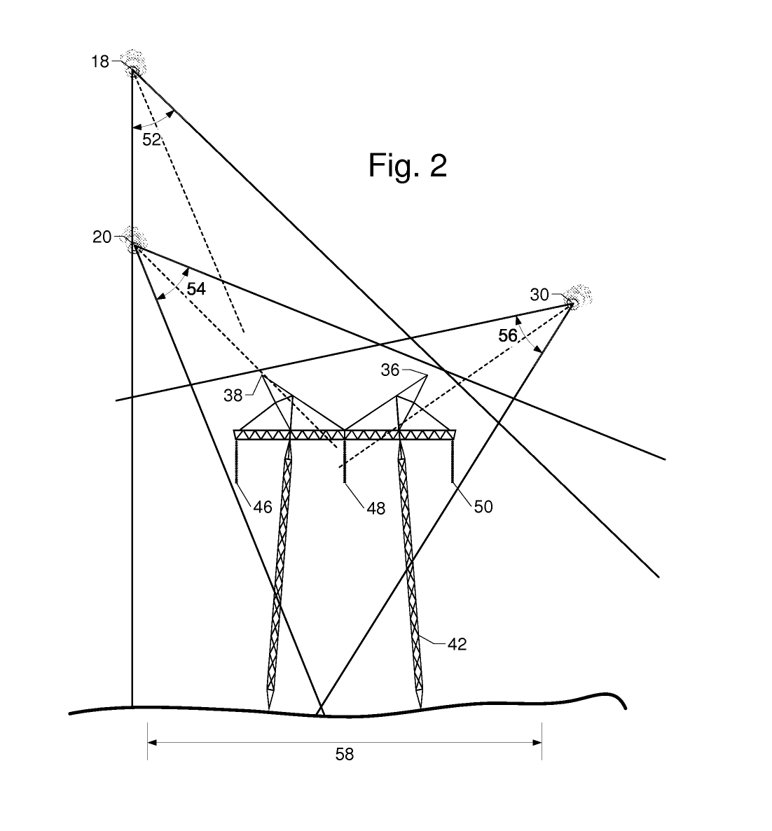

FIG. 2 is a cross-path section of the corridor inspection flight path of FIG. 1 at tower 42. For linear right of way glide 18, the angle of view 52 encompasses the entire right of way 58 and tower 42. Spiral tower glide 20 is flown lower and closer with angle of view 54 including the top of the tower that is least visible from the ground. Transmission towers are usually wider across the right of way than along the right of way so the spiral is modified with a more elliptic or oval shape. Conductor inspection with catenary climb 30 is flown closer still with angle of view 56 just encompassing all the wires. Single circuit transmission lines often have three phase conductors in a horizontal plane with the shield wires above them, so the conductor inspection 30 is flown low as shown. Transmission lines with two circuits are often more vertical with the phase conductors grouped (2, 2, and 2), so then conductor inspection with catenary climb 30 is flown with angle of view in a more vertical orientation. Ideally the right of way and all the objects of interest are inspected in one flight with the best possible resolution.

Transmission line inspection involves three different mission profiles, each with field of view and resolution tradeoffs. These will be illustrated in the following paragraphs with a sample camera that has a full-frame sensor (24×36 mm), 5 micron pixel spacing, and a 28 mm focal length lens.

It is desirable to capture images of the entire object of interest in one flight, rather than repeatedly flying the corridor. It is also desirable to use a fixed focal length lens since zoom lenses have changing interior orientations that make them difficult to calibrate for photogrammetry. Fixed prime lenses generally have better optical characteristics than zoom lenses of equivalent focal lengths. A wide angle lens with a 24 to 28 mm focal length (35 mm equivalent) provides a wide angle of view without excessive distortion and aberration. For transmission line inspection, cameras are usually oriented with the long sensor dimension along the flight path. This allows faster flight speeds for a given image overlap and the camera framing rate.

The angle of view for a given lens and sensor combination equals two times the arctangent of half the sensor dimension divided by the focal length

AOV=2*atan(sensor dimension/(2*focal length))

For a full-frame sensor aligned with the flight path (24 mm dimension across the path) with a 28 mm focal length lens, the angle of view is 46 degrees, as shown in FIG. 2. A 24 mm focal length lens would have a 53 degree angle of view for the same sensor. The angle of view is fixed for a given lens and image sensor and can be represented as a cone. The field of view is the width of this cone at a particular distance from the camera; it increases with further object distances. Often it is desirable to capture a major part of the object of interest in one flight. This field of view requirement sets the minimum distance from camera 16 to the object of interest.

The resolution in aerial photography is estimated by the ground sample distance (GSD). The GSD is the separation between camera pixels as projected on the ground. The GSD equals the object distance (flying height above ground here) times the pixel separation divided by the lens focal length. So for 5 micron pixels and a lens focal length of 28 mm, at a flying height of 400 feet (˜120 m), the GSD˜2.1 cm. The sample distance requirement sets the maximum distance from camera 16 to the object of interest.

The first type of mission in transmission line inspection is checking the right of way for vegetation incursion, man-made incursions, and wire clearances. A ground sample distance (GSD) of about 5 cm and an field of view (AOV) encompassing the entire right of way 58 would allow these checks. For a 28 mm equivalent lens, a flying height of about 75 m as shown in angle of view 52 in FIG. 2 would cover right of way 58 at a GSD of 1.3 cm. Flying higher gives a wider field of view and a larger GSD.

If towers 40 and 42 are 500 m apart and airframe 10 has a 20:1 glide ratio, then starting with a flying height of 75+25=100 m at tower 40 allows linear right of way glide 18 to be done with power plant 11 off. At the start of linear right of way glide 18, the field of view is larger than required, but the GSD˜1.8 cm is still fine enough to meet the mission objectives. By turning power plant 11 off, linear right of way glide 18 does not consume energy and it reduces vibration in airframe 10, thereby allowing much sharper images.

For transmission lines in hilly terrain, the towers may be at different altitudes. If tower 42 is uphill from tower 40, then the start of linear glide 18 at tower 40 will need to be higher. If the required start is so high the GSD distance gets too big, then the end of linear flight path 18 may need an additional power climb.

A second type of mission in transmission line inspection is checking towers for insulator damage (gun shots and contamination), bird nests, tripped surge arrestors, loose nuts, corrosion, etc. These can be detected with a sample distance at the tower of about ½ cm. At the 74 m flying height at the end of linear right of way glide 18, the object distance to the center conductor 48 is about 55 m to give a tower sample distance of about 1 cm. To get a smaller tower sample distance, airframe 10 enters spiral tower glide 20, again with power plant 11 off. This spiral provides higher resolution inspection images from all angles around the tower and still does not use any energy for flight.

Several more advantages accrue from turning power plant 11 off for tower inspection. First, it is much more effective to use audible and ultrasound microphones to detect corona and partial discharge. Partial discharge can be a predictor of insulator failure. Second, radio and television frequency interference is much easier to detect. Thirdly, vibration from power plant 11 is stopped, reducing blur due to camera shaking. Finally flying an arc pivoting around the point of interest reduces forward motion blur.

When the tower inspection is complete, power plant 11 is turned on at maximum efficiency in power climb 22 to increase the altitude of airframe 10 quickly, ready for next linear right of way glide 24.

The third type of mission in power line inspection is checking the wires. Phase conductors are checked for broken strands or corrosion; deteriorating splices, spacers, or dampers; and missing marker balls. Shield wires are checked for lightning damage. If a shield wire is 1.5 cm in diameter and a lightning strike melts a third of the wire, then for reliable detection the wire sample distance should be less than ¼ cm. For the example camera with 5 micron pixels and a 28 mm focal length lens, airframe 10 with camera 16 should be within 14 m of the shield wire. At that distance the field of view is not large enough to image all the wires in the configuration of FIG. 2 in one flight, so a compromise is made to fly low at 19 m away as shown by angle of view 56. The airframe has to fly catenary arcs to maintain this field of view. Power plant 11 can be turned off on the downslope catenary glide 28 and turned back on during the catenary climb 30.

Inspection of the wires described in the previous paragraph required a compromise between the field of view and the desired sample distance. This compromise is decided by a person since it entails a decision on which parameter is more important for that inspection flight segment. A very flexible approach is to provide a small computer aided design (CAD) interface to allow the operator to manipulate the corridor geometry and the angles of view for different missions to produce figures much like FIG. 2. Specifically, the operator chooses a starting geometry for the object of interest (e.g. tower profiles for different voltages; above/underground pipelines in shared trenches; highway, divided road, multilane road, single lane road, or track for transportation corridors). Then the interface allows the operator to adjust locations and size of on-screen representations of corridor elements to match the actual corridor geometry. Finally the operator adjusts the location and rotation of the angle of view 56 to match the mission objective. The interface provides interactive feedback showing the sample distances, so the operator can make an informed choice when it is difficult to provide the desired field of view at the desired sample distance for the given camera, sensor, and lens.

FIG. 3 illustrates a screen from such a CAD interface for planning flight segment 30.

Interactive flight segment planner runs on a computer with a display 60, input device(s) 62, processor 64, memory and storage 66, cursor 70, tooltip 72, translation icon 74, rotation icon 76, and next indicator 78. These are all prior art and a number of different configurations can be used such as desktop computers with keyboards and mice, laptops with touch pads, tablets with touch screens, smart phones, etc.

Display 60 shows a scale representation of transmission line tower 42 supporting phase conductors 46, 48, 50 and shield wires 36 and 38 within right of way 58. Angle of view 56 of aerial camera 16 is illustrated by a cone originating at the lens in camera 16. The sample distance at different locations on the object of interest is displayed either as a tooltip 72 for an input device 62 represented by a cursor 70; or on the screen upon a touch at that location for touch input. Hovering over, selecting, or touching locations on the object of interest (e.g. 36, 38, 46, 48, 50, 42, or 58) displays the sample distance at that location. The sample distance can be displayed in a tooltip, popup, or persistent screen location.

Selecting the cone representing angle of view 56 highlights it and displays translate 74 or rotate 76 icons. The interface details to select, highlight, translate, or rotate depend on the user interface standards for the operating system (e.g. Mac, Windows, or Android), window system (e.g. Motif or Ubuntu), and applications (e.g. AutoCAD or SolidWorks) the operator is used to. For example, the highlight could be nine boxes or a bold outline. Translate 74 and rotate 76 icons may appear immediately, or may replace pointer cursor 70 with a translate or rotate cursor when the pointing device is moved over the cone representing angle of view 56. Sample distances could be displayed as tooltips for cursor-based interfaces, as persistent overlays, in a particular section of the screen, or as popup overlays.

The operator translates the cone to change the location of the planned flight segment, or rotates the cone to change the planned angle of camera 16 at time of exposure. Each time the cone for angle of view 56 is rotated or translated the operator can check the new sample distances for locations on the object of interest. This direct, interactive feedback makes it much easier to visualize the tradeoff between angle of view 56 and sample distance to quickly reach a decision on the best compromise. Once a decision is made, the operator clicks or taps a next indicator 78 to save the location and camera angle for flight segment 30. The next indicator may be a visible button as shown here or alternatively a popup menu, keyboard shortcut, mouse mnemonic, gesture, or some other input. This interactive flight segment planning may be repeated for each segment where the field of view and sample distance requirements cannot be met automatically.

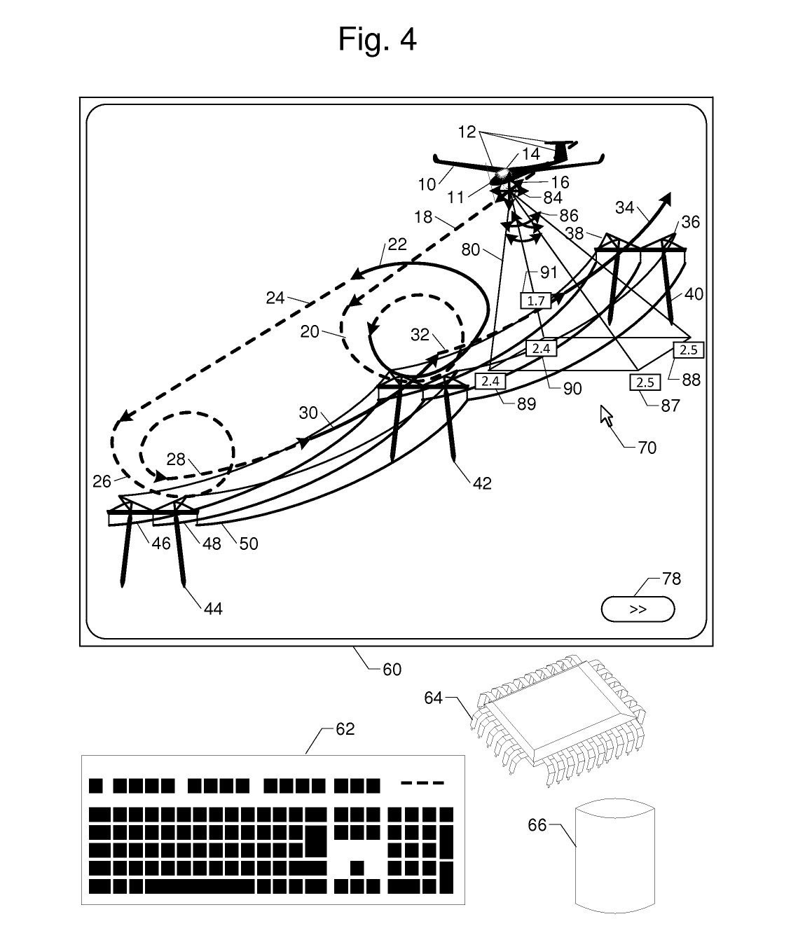

FIG. 4 is the perspective view of FIG. 1 on display 60, with input device 62, processor 64, memory and storage 66, cursor 70, translation icon 84, rotation icon 86, and next indicator 78. Translation icon 84 allows translation in three directions (up/down, left/right, forward/backward) and rotation icon 86 allows rotation about three axes (pitch, roll, and yaw). Angle of view 80 of camera 16 is represented by a three dimensional pyramid 80. In this embodiment, the operator has clicked or touched the four corners of the field of view on the ground and the sample distances to these points are displayed in small overlays 87, 88, 89, 90. The operator has also clicked shield wire 38 to display the sample distance at shield wire 38 in another overlay 91. As the operator translates 84 or rotates 86 pyramid 80, the sample distances to the five points of interest 87, 88, 89, 90, and 91 are continuously updated. Thus the operator can interactively make the tradeoff between field of view and sample distance for this flight segment. When the operator clicks or taps the next indicator 78, the location and rotation of pyramid 80 are saved to the flight plan. The location specifies a waypoint for airframe 10 and the rotation specifies an angle for camera 16.

The above examples are for a transmission line, but other overhead lines such as distribution, telephone, cable TV, and electric railway lines plus their associated supports can be inspected with this efficient flight path.

Other utilities in corridors such as oil, gas, and water pipelines can be inspected with a similar flight path. The right of way is inspected for encroachment, signs of leaks (dead vegetation, discoloration, Airborne Laser Methane Assessment), sunken backfill, erosion, and evidence of heavy traffic. The pumping or compressor stations and valves are inspected for leaks, corrosion, and deterioration in much more detail.

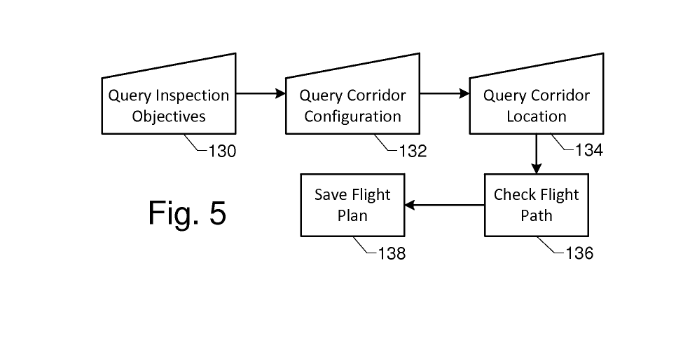

FIG. 5 is a flowchart representing the flight planning for an efficient corridor inspection to be run on the computer from FIG. 3 prior to the flight. First the system queries the operator on the inspection objectives 130. Then it queries for the corridor and object of interest configuration 132 and location 134, either from operator input or from other data sources. With these inputs it checks the flight path 136 against regulatory, airframe, and camera constraints. Finally it saves the flight parameters 138.

The inspection objectives 130 include the minimum field of view, maximum sample distance, and photo overlap for each mission profile. For the transmission line example illustrated in FIGS. 1 and 2, the right of way inspection is done with an angle of view 52 encompassing the entire right of way as well as the towers, with a minimum ground sample distance of ˜5 cm. The picture end overlap along the path is set to 10-20% to allow matching and mosaicking of adjacent images. The tower inspection is done with angle of view 54 encompassing the top of the tower with a tower sample distance of ½ cm. For a point of interest the operator can specify how many pictures around the point are required, e.g. 4 for principal compass points, 8 to include intermediate directions, 16, etc. The detailed inspection of the wires is done with angle of view 56 just encompassing all the wires with a wire sample distance of ¼ cm and ˜10% overlap. For detailed inspection between the points of interest, the operator specifies whether the flight path should match catenary arcs 28, 30, 32, 34; the terrain elevation for pipelines; or the roadbed/railbed for transportation corridors.

The corridor configuration 132 includes the width of the right of way as a minimum. The operator may specify the flight path lateral offsets from the right of way centerline, both for asymmetric corridors, as well as for those situations where adjacent landowners may not agree to overflights for their property. The vertical elements in the right of way, e.g. towers 40, 42, 44; bridges, signs, signals, pump houses, etc. have a big impact on the field of view and flight height above ground. For the transmission line example of FIGS. 1 and 2, the tower height, width, phase conductor spacing and geometry, and shield wire location and geometry define the field of view.

The corridor location is defined by a set of waypoints (latitude, longitude, and altitude) for both the corridor centerline and the points of interest. If readily available, these may be entered by the operator. Easier for the operator is to ask for starting and ending points and then to trace the corridor on maps or satellite images. For example, in satellite imagery with ˜0.5-1 m resolution (e.g. Google and Bing), power transmission towers can be clearly identified, and depending on the light and contrast with the background, the phase conductors may be visible. While mapping the corridor location it is helpful to define a number of accessible planned and emergency landing sites.

After the mission objectives 130, corridor configuration 132, and location 134 are known the flight path has to be checked 136 against regulatory, airframe, and camera constraints. UAV operation is limited within a certain radius of airports (e.g. 3 miles in US), over military installations, or in other restricted airspace. Given the waypoints for the corridor location 134 and the flight height above ground from the corridor configuration 132, the flight path can be checked against government maps published for pilots. If problems are detected, the system can allow the operator to split the inspection into multiple segments, or suggest they ask an exemption for the flight.

A fixed wing airframe will have a minimum flight speed of about 20% more than the stall speed, a maximum climb rate, specific glide slope, and fuel or battery capacity. The camera will have a maximum framing rate, a limit on picture storage, and a limit on battery life. The flight paths have to be checked against each of these limits with some reasonable estimates of headwinds to avoid problems in the field. If satellite imagery is available, then a simulated flight over the terrain (e.g. Google Earth) makes a quick check for errors or slipups in altitude or location.

After the flight path check 136, the flight parameters are saved 138 for current and future inspections of the corridor. The flight parameters include

Right of Way Inspection: Both port and starboard flight paths, including lateral offsets from corridor centerline, maximum height above ground for desired sample distance, minimum height above ground for desired field of view, camera declination from horizontal at both maximum and minimum heights, and image overlaps.

Point Inspection: Object location and height above ground relative to corridor centerline waypoint, maximum distance from object for desired sample distance, minimum object distance for desired field of view, camera declination from horizontal for maximum and minimum distances, and number of images spaced at angles around object.

Detailed Inspection: Camera offset lateral and vertical to get field of view; follow catenary (overhead electrical lines), terrain (pipelines), or road/railbed (transport); and image overlaps.

Corridor: Waypoint latitude, longitude, and altitude for the corridor and each point of interest, including planned and emergency landing sites and transposition towers.

This section illustrated details of specific embodiments, but persons skilled in the art can readily make modifications and changes that are still within the scope. For example, the figures have illustrated a fixed wing UAV, but interactive flight segment planning is also applicable to a rotary wing. The embodiments described have focused on inspection with a camera, but other inspection sensors such as UV cameras, IR cameras, LiDAR, RADAR, audible and ultrasound noise, or RF noise could also be used.

I claim:

1. A method for planning a flight segment and inspection sensor angle for aerial inspection of an object of interest by an unmanned aerial vehicle with an inspection sensor comprising:
providing a display,
providing an input device operatively coupled to said display,
providing storage operatively coupled to said display and said input device,
displaying a scale representation of said object of interest on said display,
displaying a cone representing angle of view of said inspection sensor on said display,
displaying sample distance of said inspection sensor on said display for locations on said scale representation,
selecting said cone with said input device,
repositioning said cone with said input device using transformations selected from the group consisting of
translating said cone with said input device to represent a new location for said flight segment and
rotating said cone with said input device to represent a new angle for said inspection sensor,
saving said cone location and angle for said flight segment to said storage,
whereby a flight planner can interactively make the compromise between angle of view and sample distance of said inspection sensor at said object of interest.

2. The method of claim 1 wherein
said scale representation is a three dimensional representation,
angle of view of said inspection sensor is represented by a pyramid,
said repositioning are three dimensional manipulations.

3. The method of claim 1 wherein the displaying, selecting, repositioning, and saving steps are repeated for a plurality of flight segments to produce a complete flight plan.

4. The method of claim 3 further comprising
providing an autopilot on said vehicle,
communicating said complete flight plan to said autopilot.

5. The method of claim 1 wherein said inspection sensor is a camera.

6. A flight segment planning system for aerial inspection of an object of interest by an inspection sensor mounted on an unmanned aerial vehicle comprising:
a display,
a scale representation of said object of interest on said display,
a cone representing angle of view on said display of said inspection sensor,
sample distance display means to display on said display the sample distance of said inspection sensor at a location on said scale representation,
an input device connected to said display,
repositioning means to reposition said cone with a transformation selected from the group consisting of
translating said cone with said input device to represent a new location for said flight segment and
rotating said cone with said input device to represent a new angle for said inspection sensor,
a storage device connected to said display and said input device,
saving means for storing location and angle of said cone on said storage device.

7. The system of claim 6 wherein
said scale representation is three dimensional,
angle of view of said inspection sensor is represented by a pyramid on said display,
said repositioning means are three dimensional manipulations.

8. The system of claim 6 wherein
said sample distance display means, said repositioning, and said saving are repeated for a plurality of flight segments to produce a flight plan,

9. The system of claim 8 further comprising
an autopilot mounted on said unmanned aerial vehicle,
means to communicate said flight plan to said autopilot.
